(19) United States
(12) Patent Application Publication
(10) Pub. No.: US 2005/0185716 A1
(43) Pub. Date: Aug. 25, 2005

(54) Device and method for preprocessing prior to coding of a sequence of images

(76) Inventors: Jean-Yves Babonneau, L'Hermitage (FR); Jacky Dieumegard, Paris (FR); Olivier Le Meur, Talensac (FR)

Correspondence Address: JOSEPH S. TRIPOLI;PATENT OPERATIONS, THOMSON LICENSING INC., P.O. BOX 5312, PRINCETON, NJ, 08543-5312, US

(21) Appl. No.: 11/062,516

(22) Filed: Feb. 22, 2005

(30) Foreign Application Priority Data
Feb. 25, 2004 (FR) 0401870

(51) Int. Cl. H04N 7/12

(52) U.S. Cl. 375/240.16; 375/240.12

(57) ABSTRACT

The invention relates to a method and a device for preprocessing prior to coding of a sequence of images. the device comprises means of estimation of motion, for each pixel of the current frame, between the current pixel and the corresponding pixel of the previous frame and of the previous frame of like parity.

### FIELD OF THE INVENTION

The invention relates to a device and a method for preprocessing prior to coding of a sequence of video images.

### BACKGROUND OF THE INVENTION

Image coding devices are all the more effective when they code images possessing reduced temporal or spatial entropy.

They are therefore often associated with image preprocessing devices in which the images are processed in such a way as to allow better coding.

In a known manner, preprocessing devices suitable for reducing the entropy of a video sequence use linear or nonlinear filters which increase the temporal redundancy from image to image, in such a way as to decrease the cost of coding of the predicted or interpolated images.

These various procedures have, however, drawbacks including:
a reduction in the temporal definition creating effects of smoothing of homogeneous zones,
an impression of blur,
a splitting of certain contours in the case of significant motion.

The use of motion compensated filters makes it possible to reduce these drawbacks but may give rise to artefacts when the motion estimator does not estimate the motion correctly.

The invention therefore proposes the use of morphological operators carrying out a smoothing of the weak temporal variations of amplitude of each pixel.

### SUMMARY OF THE INVENTION

For this purpose, the invention proposes a device for preprocessing prior to coding of a sequence of images comprising means of estimation of motion, for each pixel of the current frame, between the current pixel and the corresponding pixel of the previous frame and of the previous frame of like parity.

According to the invention the device comprises:
means of performing a morphological processing on the pixels of the current frame with the aid of a structuring element,
means of defining the pixels of the structuring element on which the said morphological processing is performed by the means of morphological processing as a function of the motion estimation carried out on the current pixel.

According to an advantageous embodiment, the device comprises:
means of detecting whether the current pixel is regarded as forming part of a motionless zone, said to be fixed, with respect to the previous frame and with respect to the previous frame of like parity,
means of comparing with a first predetermined threshold the motion of the current pixel with respect to its position in the previous frame and with a second predetermined threshold with respect to its position in the previous frame of like parity.

According to a preferred embodiment, the means of comparing with a predetermined motion threshold the motion of the current pixel with respect to the previous frame and with respect to the previous frame of like parity compare a vector modulus calculated over a neighbourhood of the current point with the said predetermined thresholds.

In a preferred embodiment, the means of defining the pixels of the structuring element for the current pixel are suitable for forming a structuring element comprising three pixels.

In a preferred embodiment, the means of defining the pixels of the structuring element for the current pixel are suitable for selecting
the current pixel, and
if the current pixel forms part of a fixed zone with respect to the previous frame, the pixel of the previous frame with the same coordinates as the current pixel, otherwise the pixel of the previous frame, translated by the motion vector, and
if the current pixel forms part of a fixed zone with respect to the previous frame of like parity, the pixel of the previous frame with the same coordinates as the current pixel, otherwise the pixel of the previous frame of like parity, translated by the motion vector.

According to a preferred embodiment, the device comprises means of validating, as a function of the comparison with a predetermined threshold, the pixels selected so as to define the structuring element.

In an advantageous manner, the means of validating the pixels selected are suitable for validating
the pixel selected at the previous frame if the vector modulus is greater than the first predetermined threshold,
the pixel selected at the previous frame of like parity if the vector modulus is greater than the second predetermined threshold.

In a preferred embodiment, the means of performing a morphological processing are suitable for performing, on the structuring element, successively an erosion operation followed by a dilatation operation followed by an erosion operation followed by a dilatation operation.

The invention also relates to a method of preprocessing prior to coding of a sequence of images comprising a step of estimation of motion, for each pixel of the current frame, between the current pixel and the corresponding pixel of the previous frame and of the previous frame of like parity. According to the invention, the method furthermore comprises the steps of:
morphological processing of the pixels of the current frame with the aid of a structuring element,
defining the pixels of the structuring element on which the said morphological processing is performed during the step of morphological processing as a function of the motion estimation carried out on the current pixel.

### BRIEF DESCRIPTION OF THE DRAWINGS

The invention will be better understood and illustrated by means of wholly nonlimiting, advantageous exemplary embodiments and implementations, with reference to the appended figures in which:

FIG. 1 represents an embodiment of a device according to the invention,

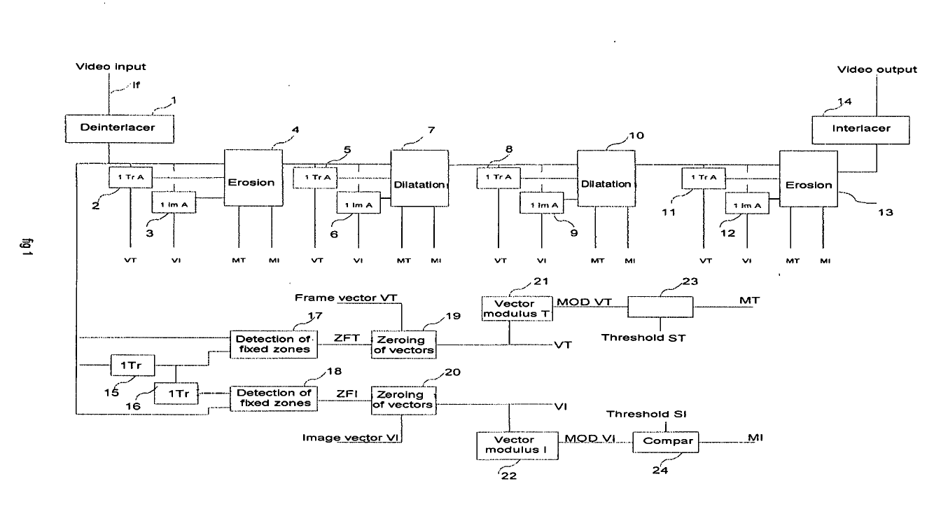

FIG. 2 represents a change in the position of a point over 3 consecutive frames.

### DETAILED DESCRIPTION OF THE PREFERED EMBODIMENT

The modules represented are functional units, which may or may not correspond to physically distinguishable units. For example, these modules or some of them may be grouped together in a single component, or constitute functionalities of one and the same software. Conversely, certain modules may possibly be composed of separate physical entities.

The video signal Si input to the precoding device is a video signal of interlaced type.

In order to improve the performance of the precoding device, the video signal Si is deinterlaced by the deinterlacer 1. The deinterlacer 1 doubles the number of lines per frame of the video signal Si using a deinterlacing method known to the person skilled in the art based on three consecutive frames of the video signal Si. Progressive frames are thus obtained which each contain the complete vertical definition of an image making it possible to subsequently perform framewise comparisons, the respective lines of two consecutive frames being spatially in the same place in the image.

A module 15 makes it possible to delay the video signal by a frame. The module 15 is advantageously composed of a static RAM type memory.

A module 17 for detecting fixed zones receives as input the deinterlaced video signal emanating from the deinterlacer 1 and the video signal delayed by a frame emanating from the module 15.

The module 17 detects the fixed zones of the current frame with respect to the previous frame.

A module 18 receives as input the video signal emanating from the deinterlacer 1 and the video signal emanating from the deinterlacer 1 delayed by two frames by a delay module 16 of the same type as the module 15.

The module 18 detects the fixed zones of the current frame with respect to the frame of like parity of the previous image.

The detection of fixed zones consists in detecting the zones which from frame to frame or from image to image remain devoid of motion. The detection of the fixed zones is performed on the basis of the luminance information and is performed on blocks of variable size. The mean error between the blocks with the same coordinates of each frame is calculated. This error is compared with a predetermined threshold to validate or otherwise the fixed zone. The weaker the size of the blocks, the more accurate the analysis is but the more sensitive it is to noise.

The fixed zones are not calculated for each pixel of the image but for blocks of 2*2 pixels, so as to ensure a degree of stability.

The module 17 outputs a signal ZFT which indicates that the current pixel forms part of a zone said to be fixed with respect to the previous frame.

The module 18 outputs a signal ZFI which indicates that the current pixel forms part of a zone said to be fixed with respect to the frame of like parity of the previous image.

A module 19 receives as input the signal ZFT. The module 19 also receives as input a frame motion vector for the current pixel.

A module 20 receives as input the signal ZFI. The module 20 also receives as input an image motion vector for the current pixel.

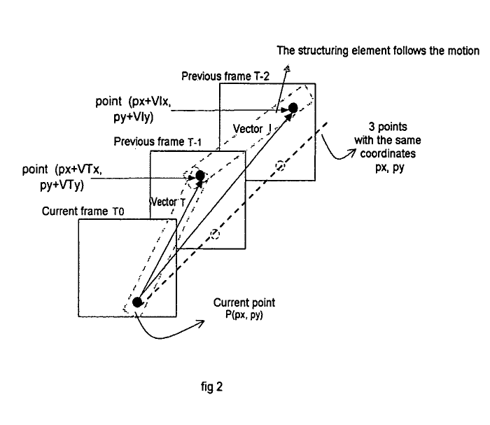

The frame and image motion vectors are calculated by a module (not represented) making it possible to calculate the frame motion vectors according to procedures known to the person skilled in the art. FIG. 2 illustrates the motion of the current point from one frame to another.

The modules 19 and 20 zero the motion vectors of the points being detected as being fixed zones.

Hence, at the output of the modules 19 and 20 are obtained the motion vectors VT and VI for the pixels which are not detected as a fixed zone and zero vectors for the pixels which are detected as a fixed zone. The vectors VT and VI are illustrated in FIG. 2.

A vector module 21 receives as input the motion vectors emanating from the module 19.

A vector module 22 receives as input the motion vectors emanating from the module 20.

The vector module 21 calculates a vector modulus MOD VT according to the following formula:
MODVT=VTx²+VTy²

The vector module 22 calculates a vector modulus MOD VI according to the following formula:
MODVI=VIx²+VIy²

VTx, VTy, VIx and VIy represent the respective coordinates of the moduli VT and VI along the horizontal axis and along the vertical axis.

The vector moduli MOD VI and MOD VT are calculated in blocks of two pixels. This advantageously makes it possible to minimize the instabilities of the image.

The modules 21 and 22 are respectively connected to the input of two comparators 23 and 24.

The comparators 23 and 24 also respectively receive as input thresholds ST and SI.

The thresholds ST and SI are equal to or different depending on the applications.

The comparators 23 and 24 respectively compare the values of MODVT and MODVI with predetermined thresholds ST and SI.

The thresholds ST and SI represent the value of the moduli MODVT and MODVI for which the motion in the block of pixels is regarded as significant.
If MODVT≧ST then MT=0 else MT=1
If MODVI>SI then MI=0 else MI=1

A psychovisual characteristic is used, according to which an object which undergoes strong motion is difficult to capture with the eye (in contradistinction to an object having medium or weak motion), thus the processing is applied if a strong motion is present, and the processing is disabled if there is a medium or weak motion; a very weak motion may be likened to a fixed zone according to the detection thresholds applied.

The video signal is also received by a delay module 2. The delay module 2 outputs the previous video frame, motion compensated, that is to say in which the coordinates of the pixels may have been modified following the motion compensation.

The video signal deinterlaced by the deinterlacer 1 is also received by a delay module 3. The delay module 3 outputs the previous video frame of like parity, motion compensated, that is to say in which the coordinates of the pixels may have been modified following the motion compensation.

A morphological operator 4 performing an erosion operation receives as input the outputs from the modules 2 and 3. The erosion module 4 also receives as input the signals MI and MT emanating respectively from the comparators 24 and 23.

The erosion module 4 performs the erosion operation on a structuring element. The structuring element is composed of the current pixel and possibly of pixels of the previous frames.

The structuring element is calculated in the following manner, in a first step:
if the current pixel is detected as being a fixed zone with respect to the previous frame (ZFT) by the module 17, the frame vector VT is equal to “0” and thus the pixel selected in the previous frame to participate in the structuring element has the same coordinates in the frame as the current pixel;
if the current pixel is not detected as being a fixed zone with respect to the previous frame by the module 17, the frame vector VT points towards the pixel with coordinates (px+VTx, py+VTy), and it is this pixel of the previous frame which forms part of the structuring element;
if the current pixel is detected as being a fixed zone with respect to the previous frame of like parity (ZFI) by the module 18, the image vector VI is equal to “0” and thus the pixel selected in the previous image to participate in the structuring element has the same coordinates as the current pixel;
if the current pixel is not detected as being a fixed zone with respect to the previous image by the module 18, the image vector VI points towards the pixel with coordinates (px+Vix, py+Viy), and it is this pixel of the previous image which forms part of the structuring element.

In a second step the structuring element as previously calculated is modified as a function of the masks MI and MT.
If MI is inactive, this signifies that the motion in a 2*2 block (two pixels by two pixels) in progress, including the current pixel, is regarded as significant enough to apply the morphological operators, and the pixel previously selected with coordinates (px+Vix, py+Viy) in the previous frame, is validated to participate in the structuring element,
if MI is active then the pixel previously selected with coordinates (px+Vix, py+Viy) in the previous frame is not validated to participate in the structuring element which then possesses one pixel less than envisaged,
if MT is inactive, this signifies that the motion in a 2*2 block (two pixels by two pixels) in progress, including the current pixel, is regarded as significant enough to apply the morphological operators, and the pixel previously selected with coordinates (px+Vix, py+Viy) in the previous image, is validated to participate in the structuring element,
if MT is active then the pixel previously selected with coordinates (px+Vix, py+Viy) in the previous image is not validated to participate in the structuring element which then possesses one pixel less than envisaged.

Thus, the structuring element of each morphological operator may consist of 3, 2 or 1 pixel which is then the current pixel.

The erosion module 4 therefore performs the erosion operation on the structuring element previously calculated.

The erosion function consists in keeping the pixel having the minimum value from among the pixels of the structuring element.

By way of illustrative example:
if MI is inactive and MT is inactive if VI=VT=0 then as output from the erosion module we have out=MIN(previous image pixel, previous frame pixel, current pixel),
if VT=1 and VI=2 then as output from the erosion module we have out=MIN(previous image pixel −2, previous frame pixel −1, current pixel).
If MI is active and MT is inactive, if VT=1 and VI=2 then as output from the erosion module we have out=MIN(previous frame pixel −1, current pixel).

Subsequently, the output of the erosion module 4 is connected to the input of a morphological operator 7 which performs a dilatation operation.

The dilatation module 7 also receives as input the output from the module 4, motion compensated and delayed by a frame (which is the output of a delay module 5) as well as the output of the module 4, motion compensated and delayed by an image (in fact the previous frame of like parity) which is the output of a delay module 6.

The dilatation operation is performed on the pixels of the structuring element.

The dilatation operation consists in keeping the pixel having the maximum value from among the pixels of the structuring element.

The output of the dilatation module 7 is connected to the input of a second dilatation module 10. The module 10 also receives as input the output of the module 7, motion compensated and delayed by a frame (which is the output of a delay module 8) as well as the output of the module 6, motion compensated and delayed by an image (in fact the previous frame of like parity) which is the output of a delay module 9.

The dilatation operation performed by the module 10 consists in taking the maximum from among the pixels of the structuring element as defined previously.

The output of the dilatation module 10 is connected to the input of a second erosion module 13. The module 13 also receives as input the output of the module 10, motion compensated and delayed by a frame (which is the output of a delay module 11) as well as the output of the module 10, motion compensated and delayed by an image (in fact the previous frame of like parity) which is the output of a delay module 12.

The erosion operation is performed on the pixels of the structuring element and consists in keeping the pixel having the minimum value from among the pixels of the structuring element.

The morphological operators therefore perform an opening operation (which consists of an erosion followed by a dilatation) followed by a closing operation (dilatation followed by an erosion).

In other embodiments, it is possible to perform the closing operation before the opening operation.

The output of the erosion module is subsequently transmitted to an interlacing module 14 which transforms the progressive video signal into an interlaced video signal.

The video signal is subsequently transmitted in an advantageous manner to a video coding device. The coding device can perform the video coding on the video signal whose entropy has been reduced.

The invention is of course not limited to the exemplary embodiment described hereinabove.

1. Device for preprocessing prior to coding of a sequence of images comprising
means of estimation of motion, for each pixel of the current frame, between the current pixel and the corresponding pixel of the previous frame and of the previous frame of like parity,
wherein it comprises
means of performing a morphological processing on the pixels of the current frame with the aid of a structuring element,
means of defining the pixels of the structuring element on which the said morphological processing is performed by the means of morphological processing as a function of the motion estimation carried out on the current pixel.

2. Device according to claim 1, wherein it comprises
means of detecting whether the current pixel is regarded as forming part of a motionless zone, said to be fixed, with respect to the previous frame and with respect to the previous frame of like parity,
means of comparing with a first predetermined threshold the motion of the current pixel with respect to its position in the previous frame and with a second predetermined threshold with respect to its position in the previous frame of like parity.

3. Device according to claim 2, wherein the means of comparing with a predetermined motion threshold the motion of the current pixel with respect to the previous frame and with respect to the previous frame of like parity compare a vector modulus calculated over a neighbourhood of the current point with the said predetermined thresholds.

4. Device according to claim 3, wherein the means of defining the pixels of the structuring element for the current pixel are suitable for forming a structuring element comprising three pixels.

5. Device according to claim 4, wherein the means of defining the pixels of the structuring element for the current pixel are suitable for selecting
the current pixel, and
if the current pixel forms part of a fixed zone with respect to the previous frame, the pixel of the previous frame with the same coordinates as the current pixel, otherwise the pixel of the previous frame, translated by the motion vector, and
if the current pixel forms part of a fixed zone with respect to the previous frame of like parity, the pixel of the previous frame with the same coordinates as the current pixel, otherwise the pixel of the previous frame of like parity, translated by the motion vector.

6. Device according to claim 5, wherein it comprises means of validating, as a function of the comparison with a predetermined threshold, the pixels selected so as to define the structuring element.

7. Device according to claim 6, wherein the means of validating the pixels selected are suitable for validating
the pixel selected at the previous frame if the vector modulus is greater than the first predetermined threshold,
the pixel selected at the previous frame of like parity if the vector modulus is greater than the second predetermined threshold.

8. Device according to claim 1, wherein the means of performing a morphological processing are suitable for performing, on the structuring element, successively an erosion operation followed by a dilatation operation followed by an erosion operation followed by a dilatation operation.

9. Method of preprocessing prior to coding of a sequence of images comprising a step of estimation of motion, for each pixel of the current frame, between the current pixel and the corresponding pixel of the previous frame and of the previous frame of like parity,
wherein it comprises the steps of
morphological processing of the pixels of the current frame with the aid of a structuring element,
defining the pixels of the structuring element on which the said morphological processing is performed during the step of morphological processing as a function of the motion estimation carried out on the current pixel.
